(19) United States
(12) Patent Application Publication
(10) Pub. No.: US 2008/0309856 A1
(43) Pub. Date: Dec. 18, 2008

(54) Polarized Light Source

(75) Inventors: Udayan Kanade, Pune (IN); Gaurav Kulkarni, Sangli (IN); Karthikk Sridharan, Pune (IN); Manas Alekar, Pune (IN); Manohar D. Joshi, Pune (IN); Sanat D. Ganu, Pune (IN); Balaji Ganapathy, Pune (IN)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: I2iC Corporation

(21) Appl. No.: 12/133,707

(22) Filed: Jun. 5, 2008

(30) Foreign Application Priority Data
Jun. 5, 2007 (IN) 1060/MUM/2007

(51) Int. Cl. G02F 1/1335

(52) U.S. Cl. 349/98

(57) ABSTRACT

An energy efficient polarized light source system is disclosed. In one embodiment, the system comprises a reflector and a reflecting polarizer. A transparent light source and a wave retarder are placed in between the reflector and reflecting polarizer.

This invention claims priority to Indian Provisional Patent No. 1060/MUM/2007 entitled “A polarized light source,” filed on Jun. 5, 2007.

### FIELD

The present invention relates to the fields of optics, materials and electronics. More particularly, the invention relates to an energy efficient polarized light source.

### BACKGROUND

Light from most light sources is randomly polarized. However, several applications require linearly or circularly polarized light. For example, many light valves (e.g. liquid crystal displays) and optical processors require linearly polarized light.

Prior art systems exist which convert randomly polarized light to polarized light. Some prior art systems use a polarizer in front of the light source. Unpolarized light passes through the polarizer and polarized light emerges from it. Such systems are inefficient since polarizers allow transmission of one polarization component but absorb the other polarization component. Thus, approximately half the light energy is dissipated in the polarizer.

Other prior art systems use polarizing beam splitters for polarizing light. Polarizing beam splitters allow the required polarization component to pass through, however, the unwanted polarization component is deflected away and its energy is dissipated elsewhere. Therefore, such systems are also inefficient.

Some prior art systems use the following components: a mirror, a light source in the form of a sheet, a quarter wave retarder sheet and a reflecting polarizer sheet. The reflecting polarizer is a device which permits one polarization component to pass through, but reflects back the other polarization component. This other polarization component is recycled by the quarter wave retarder, the light source and the mirror. These prior art systems are inefficient. The light source, being non transparent, causes light polarization to be disrupted whenever light passes through it. Thus, a high light recycling efficiency is not achieved.

### SUMMARY

An energy efficient polarized light source system is disclosed. In one embodiment, the system comprises a reflector and a reflecting polarizer. A transparent light source and a wave retarder are placed in between the reflector and reflecting polarizer.

The above and other preferred features, including various details of implementation and combination of elements are more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1A illustrates a block diagram of a cross section of an exemplary polarized light source, according to one embodiment.

FIG. 1B illustrates a block diagram of a cross section of an exemplary polarized light source depicting polarization states of exemplary light rays, according to one embodiment.

FIG. 2A illustrates a block diagram of a cross section of an exemplary apparatus of a polarized light source, according to one embodiment.

FIG. 2B illustrates a block diagram of a cross section of an exemplary polarized light source depicting polarization states of exemplary light rays, according to one embodiment.

FIG. 3A illustrates a block diagram of a cross section of an exemplary polarized light source, according to one embodiment.

FIG. 3B illustrates a block diagram of a cross section of the exemplary polarized light source depicting polarization states of exemplary light rays, according to one embodiment.

FIG. 4A illustrates a block diagram of a cross section of an exemplary polarized light source, according to one embodiment.

FIG. 4B illustrates a block diagram of a cross section of the exemplary polarized light source depicting polarization states of exemplary light rays, according to an embodiment.

FIG. 5A illustrates a block diagram of an exemplary transparent light source, according to one embodiment.

FIG. 5B illustrates a block diagram of an exemplary transparent light source as viewed from the side, according to one embodiment.

FIG. 6 illustrates a block diagram of an exemplary element of core of exemplary light source, according to one embodiment.

FIG. 7 illustrates a diagram of an exemplary light source having a varied concentration of diffuser particles, according to one embodiment.

FIG. 8 illustrates an exemplary light source having two light sources, according to one embodiment.

FIG. 9 illustrates a diagram of an exemplary light source having a mirrored core, according to one embodiment.

### DETAILED DESCRIPTION

An energy efficient polarized light source system is disclosed. In one embodiment, the system comprises a reflector and a reflecting polarizer. A transparent light source and a wave retarder are placed in between the reflector and reflecting polarizer.

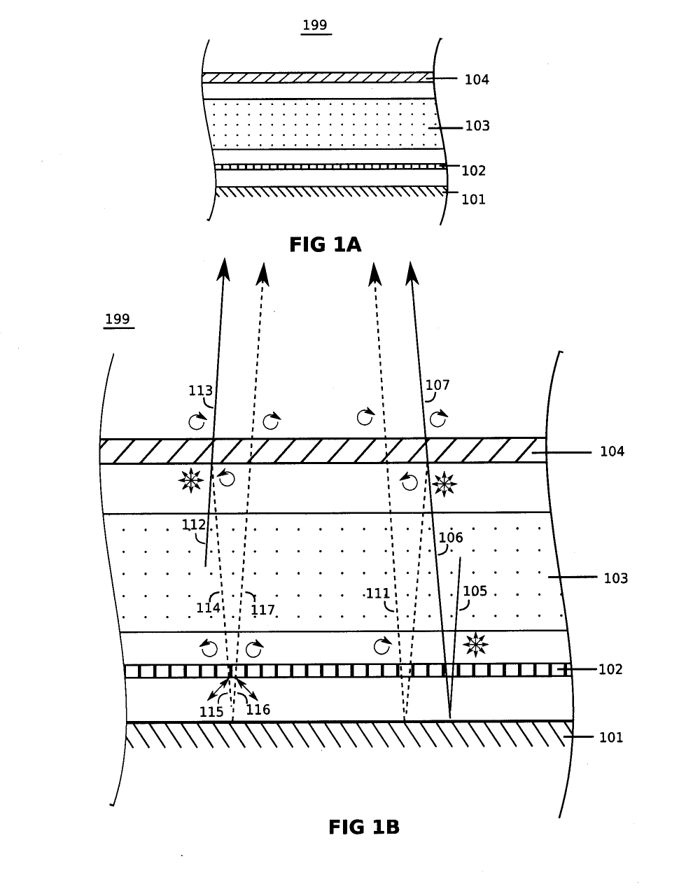

FIG. 1A illustrates a block diagram of a cross section of an exemplary polarized light source system 199, according to one embodiment. The apparatus includes a mirror 101 which may be any light reflector, including metallic surfaces, distributed Bragg reflectors, hybrid reflectors, total internal reflectors, omni-direction reflectors or scattering reflectors. A quarter wave retarder 102 is placed in front of mirror 101. A transparent light source 103 is placed in front of the quarter wave retarder 102. A reflecting circular polarizer 104 is placed in front of the transparent light source 103. The reflecting circular polarizer 104 splits light from light source 103, such that some light with circular polarization passes through it, and some light is reflected back. The polarized light source system 199 is an energy efficient light source that emits circularly polarized light.

A quarter wave retarder 102 is a birefringence device where the optical path difference between light polarized in one direction and light polarized in another direction equals one-fourth of the wavelength of light. According to one embodiment, a quarter wave retarder 102 need not be a perfect quarter wave retarder. In one embodiment, quarter wave retarder 102 has an optical path difference of a quarter wavelength over a range of wavelengths (known as a broadband quarter wave retarder.) In another embodiment, the optical path difference as a fraction of wavelength, is different for different wavelengths. In another embodiment, wave retarder 102 does not have an optical path difference, equal to one-fourth of the wavelength, but equal to any fraction of the wavelength such as one-eighth, three-fourth, etc.

FIG. 1B illustrates a block diagram of a cross section of an exemplary polarized light source 199 depicting polarization states of exemplary light rays, according to an embodiment. Light may emanate from the transparent light source 103 from both its faces. Unpolarized or partially polarized light 112 emanating from the front face of the transparent light source 103 is incident on the reflecting polarizer 104. Circularly polarized light component 113 of light 112 of a particular handedness (e.g., counterclockwise or clockwise polarizations) emerges from the reflecting polarizer 104. Circularly polarized light component 114 of light 112 of the opposite handedness is reflected back by the polarizer 104. Circularly polarized light component 114 passes through the transparent light source 103. The light source 103 being transparent, the polarization state of light 114 is retained. Further, light 114 is incident on the quarter wave retarder 102. Circularly polarized light 114 passes through the quarter wave retarder 102 and is linearly polarized. Linearly polarized light 115 is reflected from the mirror 101. Mirror reflection of light 115 retains its polarization state. Reflected linearly polarized light 116 passes through the quarter wave 102 and becomes circularly polarized in a handedness opposite to that of light 114. Circularly polarized light 117 passes through the transparent light source 103 and is incident on the reflecting polarizer 104. The light source 103 being transparent, the polarization state of light 117 is retained. Light 117 is circularly polarized in a handedness which is transmitted by the reflecting polarizer 104. Light 117 passes through the reflecting polarizer 104. Thus, the light 112 extracted from the front face of the transparent light source 103 is circularly polarized and emanates from the reflecting polarizer 104.

Unpolarized or partially polarized light 105 emanating from the back face of the transparent light source 103 passes through quarter wave retarder 102, is reflected by mirror 101, passes again through quarter wave retarder 102, and through transparent light source 103 to give unpolarized or partially polarized light 106. Unpolarized or partially polarized light 106 is incident on the reflecting polarizer 104 in a similar fashion to light 112 emanating from the front face of the transparent light source 103, and thus undergoes similar transformations as light 112 undergoes, to give circularly polarized light 107 and circularly polarized light 111 of the same handedness as light 113. Thus, the light 105 extracted from the back face of the transparent light source 103 is circularly polarized and emanates from the reflecting polarizer 104. Light extracted from both the faces of the transparent light source 103 emerges from light system 199 in a circularly polarized state.

If the wave retarder 102 is not a perfect quarter wave retarder, then some of the light reflected by the reflecting polarizer 104 will not be initially polarized by the reflecting polarizer 104. In this case, the part that is not polarized will be reflected again, until most (if not all) light is polarized by the reflecting polarizer 104. Thus, light emanates out of light source 199 after multiple bounces.

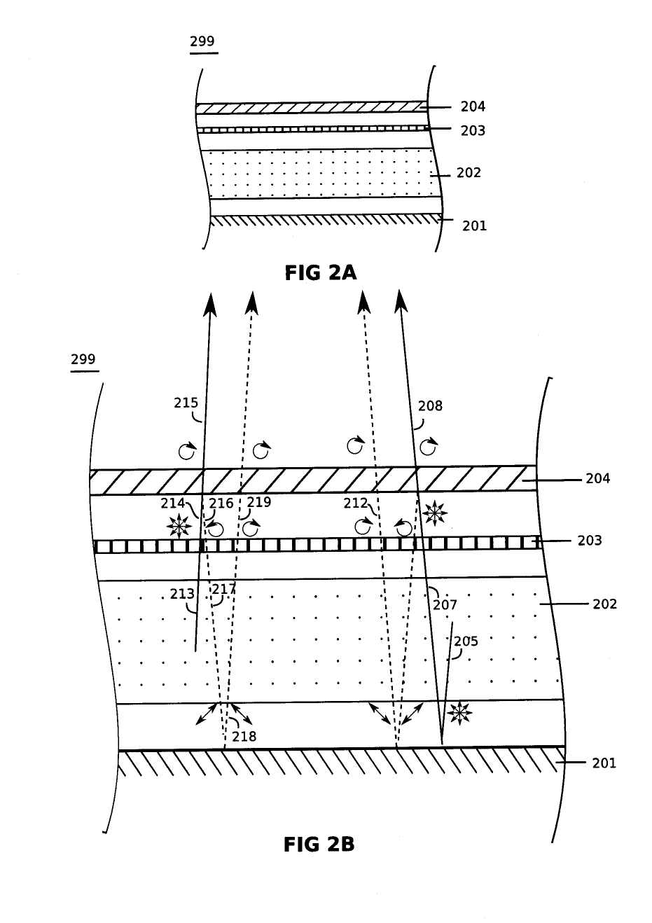

FIG. 2A illustrates a block diagram of a cross section of an exemplary polarized light source 299, according to one embodiment. Light source system 299 includes a mirror 201 that may be any light reflector, including metallic surfaces, distributed Bragg reflectors, hybrid reflectors, total internal reflectors, omni-direction reflectors or scattering reflectors. A transparent light source 202 is placed in front of the mirror 201. A quarter wave retarder 203 is placed in front of transparent light source 202. A reflecting circular polarizer 204 is placed in front of the quarter wave retarder 203. The reflecting circular polarizer 204 allows one circular polarization to pass through it, but reflects back the other circular polarization. The light source system 299 is an energy efficient light source which emits circularly polarized light.

In an alternate embodiment, more than one wave retarder is used. The wave retarders may be placed both between the mirror 201 and the transparent light source 202 and between the transparent light source 202 and reflecting polarizer 204.

FIG. 2B illustrates a block diagram of a cross section of light source system 299 depicting polarization states of exemplary light rays, according to an embodiment. Light may emanate from the transparent light source 202 from both its faces. Unpolarized or partially polarized light 213 emanating from the front face of the transparent light source 202, passes through the quarter wave retarder 203 to form unpolarized or partially polarized light 214. Unpolarized or partially polarized light 214 is incident on the reflecting polarizer 204. Circularly polarized light component 215 of light 214 of a particular handedness is transmitted through the reflecting polarizer 204. Circularly polarized light component 216 of light 214 of the opposite handedness is reflected back by the reflecting polarizer 204. Circularly polarized component 216 passes through the quarter wave retarder and becomes linearly polarized. Linearly polarized light 217 passes through the transparent light source 202 and reflects from the mirror 201. The light source 202 being transparent, the polarization state of light 217 is retained. Mirror reflection of light 217 retains its polarization. Reflected linearly polarized light 218 passes through the transparent light source 202. Because the light source 202 is transparent, the polarization state of light 218 is retained. Further, light 218 passes through the quarter wave retarder 202 and becomes circularly polarized in a handedness opposite to that of light 216. Circularly polarized light 219 has a handedness which is transmitted by the reflecting polarizer 204. Circularly polarized light 219 passes through the reflecting polarizer 204. Thus, light 213 extracted from the front face of the transparent light source is circularly polarized and emanates from the reflecting polarizer 204.

Unpolarized or partially polarized light 205 emanating from the back face of the transparent light source 202 is reflected by mirror 201 and passes through transparent light source 202 to give unpolarized or partially polarized light 207. Unpolarized or partially polarized light 207 is incident on the quarter wave retarder 203 in a similar fashion to light 213 emanating from the front face of the transparent light source 202, and thus undergoes similar transformation as light 213 undergoes, to give circularly polarized light 208 and circularly polarized light 212 of the same handedness as light 215. Thus, light 205 extracted from the back face of the transparent light source 202 is circularly polarized and emanates from the reflecting polarizer 204. Light extracted from both the faces of the transparent light source 202 emerges from light source system 299 in a circularly polarized state.

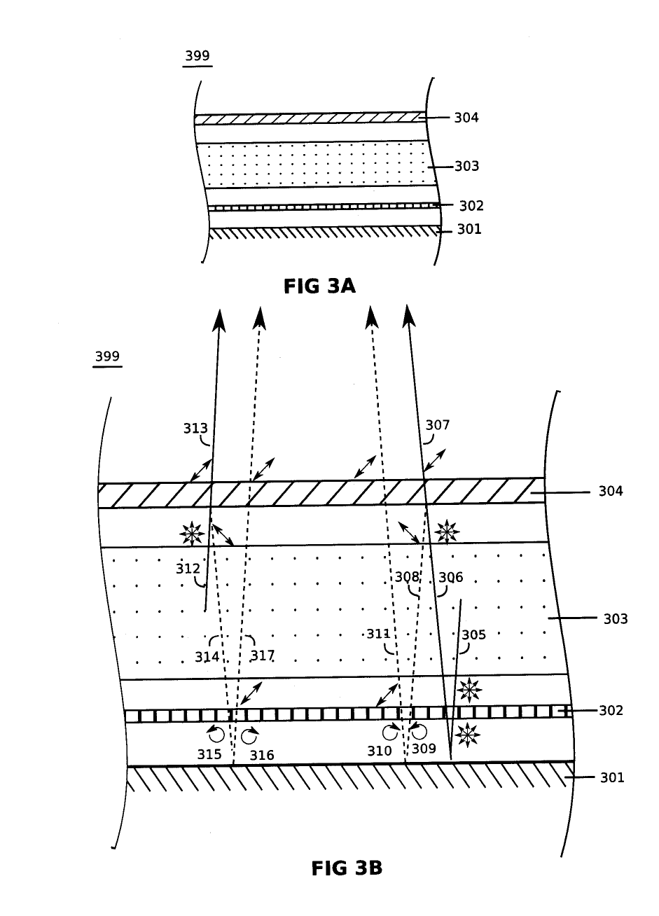

FIG. 3A illustrates a block diagram of a cross section of a polarized light source system 399, according to one embodiment. Light source system 399 includes a mirror 301 that may be any light reflector, including metallic surfaces, distributed Bragg reflectors, hybrid reflectors, total internal reflectors, omni-direction reflectors or scattering reflectors. A quarter wave retarder 302 is placed in front of mirror 301. A transparent light source 303 is placed in front of the quarter wave retarder 302. A reflecting linear polarizer 304 is placed in front of the transparent light source 303. The reflecting linear polarizer 304 allows one linear polarization component of light to pass through it, but reflects back the perpendicular linear polarization component of light. In one embodiment, the optical axis of the quarter wave retarder plate 302 makes an angle of 45 degrees with the direction of polarization of the light reflected back by the linear polarizer. Light source system 399 is an energy efficient light source which emits linearly polarized light.

FIG. 3B illustrates a block diagram of a cross section of light source system 399 depicting polarization states of exemplary light rays, according to an embodiment. Light may emanate from the transparent light source 303 from both its faces. Unpolarized or partially polarized light 312 emanating from the front face of the transparent light source 303 is incident on the reflecting polarizer 304. Linearly polarized light component 313 of light 312 having a particular polarization direction emerges from the reflecting polarizer 304. Linearly polarized light component 314 of light 312 having a polarization direction perpendicular to that of light 313 is reflected back by the polarizer 304. Linearly polarized light component 314 passes through the transparent light source 303. Because the light source 303 is transparent, the polarization state of light 314 is retained. Further, linearly polarized light 314 passes through the quarter wave retarder 302 and is circularly polarized. Circularly polarized light 315 is reflected from the mirror 301. Reflected circularly polarized light 316 having a handedness opposite to that of light component 315 passes through the quarter wave 302 and becomes linearly polarized in a direction perpendicular to that of light 314. Linearly polarized light 317 passes through the transparent light source 103 and is incident on the reflecting polarizer 304. Because the light source 303 is transparent, the polarization state of light 317 is retained. Light 317 is linearly polarized in a direction that is transmitted by the reflecting polarizer 304. Light 317 passes through the reflecting polarizer 304. Thus, the light 312 extracted from the front face of the transparent light source 303 is linearly polarized and emanates from the reflecting polarizer 304.

Unpolarized or partially polarized light 305 emanating from the back face of the transparent light source 303 passes through quarter wave retarder 302, is reflected by mirror 301, passes again through quarter wave retarder 302, and through transparent light source 303 to give unpolarized or partially polarized light 306. Unpolarized or partially polarized light 306 is incident on the reflecting polarizer 304 in a similar fashion to light 312 emanating from the front face of the transparent light source 303. Linearly polarized light 307 and linearly polarized light 311 are polarized in the same direction as light 313. Thus, the light 305 extracted from the back face of the transparent light source 303 is linearly polarized and emanates from the reflecting polarizer 304. Light extracted from both the faces of the transparent light 303 source emerges from light source 399 in a linearly polarized state.

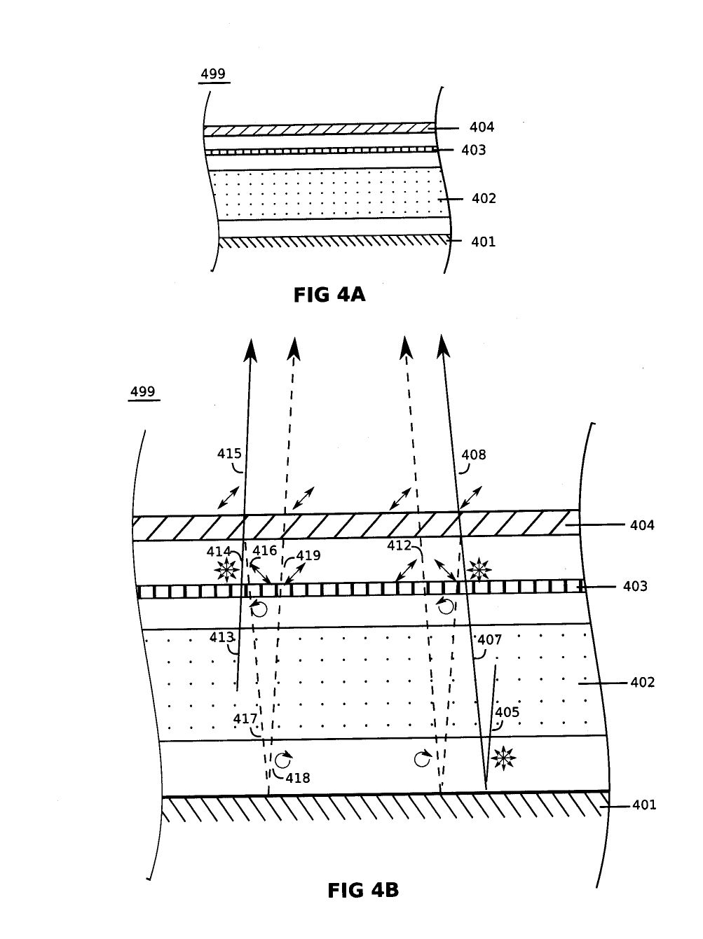

FIG. 4A illustrates a block diagram of a cross section of an exemplary polarized light source 499, according to one embodiment. The apparatus comprises a mirror 401 that may be any light reflector, including metallic surfaces, distributed Bragg reflectors, hybrid reflectors, total internal reflectors, omni-direction reflectors or scattering reflectors. A transparent light source 402 is placed in front of the mirror 401. A quarter wave retarder 403 is placed in front of transparent light source 402. A reflecting linear polarizer 404 is placed in front of the quarter wave retarder 403. The reflecting linear polarizer 404 allows one linear polarization component of light to pass through it, but reflects back the perpendicular linear polarization component of light. The light source system 499 is an energy efficient light source which emits linearly polarized light.

FIG. 4B illustrates a block diagram of a cross section of the exemplary apparatus 499 depicting polarization states of exemplary light rays, according to an embodiment. Light may emanate from the transparent light source 402 from both its faces. Unpolarized or partially polarized light 413 emanating from the front face of the transparent light source 402, passes through the quarter wave retarder 403 to form unpolarized or partially polarized light 414. Unpolarized or partially polarized light 414 is incident on the reflecting polarizer 404. Linearly polarized light component 415 of light 414 having a particular polarization direction is transmitted through the reflecting polarizer 404. Linearly polarized light component 416 of light 414 having a polarization direction perpendicular to that of light component 415 is reflected back by the reflecting polarizer 404. Linearly polarized component 416 passes through the quarter wave retarder 403 and becomes circularly polarized. Circularly polarized light 417 passes through the transparent light source 402 and reflects from the mirror 401. The light source 402 being transparent, the polarization state of light 417 is retained. Mirror reflection of light 417 retains its polarization state. Reflected circularly polarized light 418 passes through the transparent light source 402. Because the light source 402 is transparent, the polarization state of light 418 is retained. Further, light reflected circularly polarized light 418 passes through the quarter wave retarder 402 and becomes linearly polarized in a polarization direction perpendicular to that of light component 416. Linearly polarized light 419 has a polarization direction that is transmitted by the reflecting polarizer 404. Linearly polarized light 419 passes through the reflecting polarizer 404. Thus, light 413 extracted from the front face of the transparent light source is linearly polarized and emanates from the reflecting polarizer 404.

Unpolarized or partially polarized light 405 emanating from the back face of the transparent light source 402 is reflected by mirror 401 and passes through transparent light source 402 to provide unpolarized or partially polarized light 407. Unpolarized or partially polarized light 407 is incident on the quarter wave retarder 403, and provides linearly polarized light 408 and linearly polarized light 412 polarized in the same direction as light 415. Thus, light 405 extracted from the back face of the transparent light source 402 is linearly polarized and emanates from the reflecting polarizer 404. Thus, light extracted from both the faces of the transparent light source 402 emerges from the light source system 499 in a linearly polarized state.

### Transparent Light Source

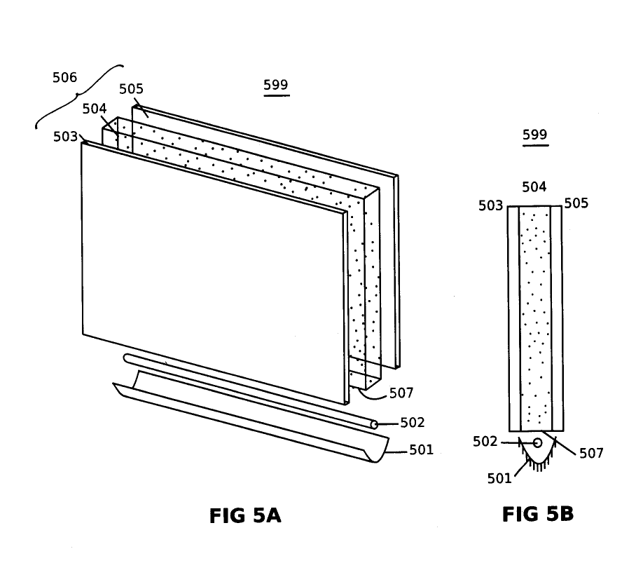

FIG. 5A illustrates a block diagram of an exemplary transparent light source 599, according to one embodiment. Light source 599 is primarily transparent and includes a light guide 506 with a core 504 surrounded by low index cladding 503 and 505. In an embodiment, the cladding is air or vacuum. The core 504 includes diffuser, which is a sparse distribution of light dispersing particles. The diffuser is made up of metallic, organic or other powder or pigment, or transparent particles or bubbles that deflect light by reflection, refraction or scattering. Linear light source 502 illuminates the light guide from one of its ends 507. Optional reflector 501 concentrates light from the linear source 502 into the light guide 506. The light from primary light source 502 travels through the light guide 506, is dispersed over the entire body of the light guide 506 and exits the light guide 506. The light guide 506 is primarily transparent and clear when viewed from outside.

FIG. 5B illustrates a block diagram of an exemplary transparent light source 599 as viewed from the side, according to one embodiment. Light source 599 is primarily transparent and is constituted of a light guide 506 with a core 504 surrounded by low index cladding 503 and 505. The core 504 includes diffuser that is a sparse distribution of light dispersing particles. Linear light source 502 illuminates the light guide from one of its ends 507. Light travels in the light guide 506 and is dispersed over the entire body of the light guide 506. Optional reflector 501 concentrates light from the linear source 502 into the light guide 506.

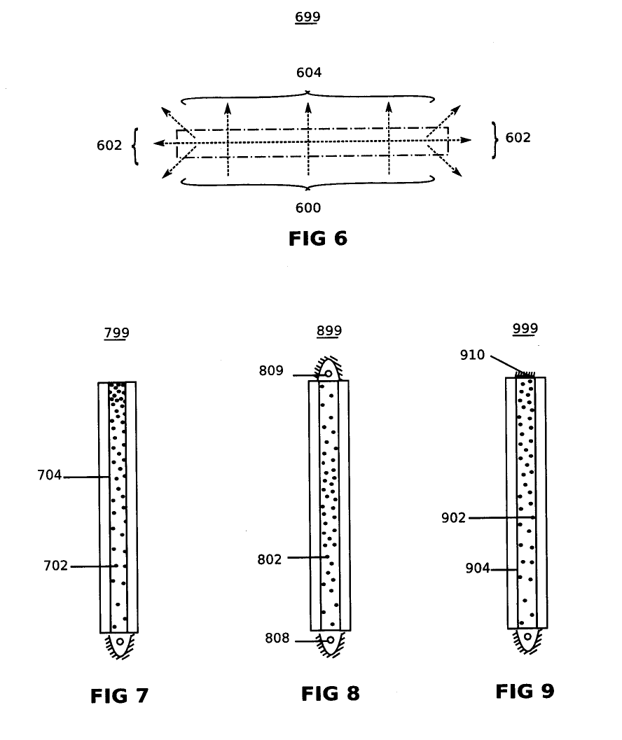

FIG. 6 illustrates a block diagram of an exemplary element 699 of a transparent light source, according to one embodiment. Core element 699 has the thickness and breadth of the core but has a very small height. Light 600 enters element 699. Some of the light 600 is dispersed and leaves the light guide as illumination light 602, and the remaining light 604 travels on to the next core element. The power of the light 600 going in is matched by the sum of the powers of the dispersed light 602 and the light continuing to the next core element 604. The ratio of the fraction of light dispersed 602 with respect to the light 600 entering the element 699, to the height of element 699 is the volume extinction coefficient of element 699. As the height of element 699 decreases, the volume extinction coefficient approaches a constant. This volume extinction coefficient of element 699 bears a certain relationship to the diffuser concentration at the element 699. The relationship permits evaluation of the volume extinction coefficient of core element 699 from the diffuser concentration of the core element 699, and vice versa.

As the height of element 699 is reduced, power in the emanating light 602 reduces proportionately. The ratio of power of the emanating light 602 to the height of element 699, which approaches a constant as the height of the element is reduced, is the emanated linear irradiance at element 699. The emanated linear irradiance at element 699 is the volume extinction coefficient times the power of the incoming light (i.e. power of light traveling through the element). The gradient of the power of light traveling through the element 699 is the negative of the emanated linear irradiance. These two relations give a differential equation. This equation can be represented in the form “dP/dh=−qP=−K” where:

h is the distance of a core element from that end of the core near which the primary light source is placed;

P is the power of the light being guided through that element;

q is the volume extinction coefficient of the element; and

K is the emanated linear irradiance at that element.

This equation is used to find the emanated linear irradiance given the volume extinction coefficient at each element. This equation is also used to find the volume extinction coefficient of each element, given the emanated linear irradiance. To design a particular light source with a particular emanated linear irradiance, the above differential equation is solved to determine the volume extinction coefficient at each element of the light source. From this, the diffuser concentration at each core element of the core is determined. Such a core is used in a light guide, to give a light source of a required emanated linear irradiance pattern.

If a uniform concentration of diffuser is used in the core, the emanated linear irradiance drops exponentially with height. Uniform emanated linear irradiance may be approximated by choosing a diffuser concentration such that the power drop from the edge near the light source to the opposite edge is minimized. To reduce the power loss and also improve the uniformity of the emanated power, the opposite edge reflects light back into the core. In an alternate embodiment, another light source projects light into the opposite edge.

To achieve uniform illumination, the volume extinction coefficient and hence the diffuser concentration has to be varied over the length of the core. This can be done using the above methodology. The required volume extinction coefficient is q=K/(A−hK), where A is the power going into the linear light source 604 and K is the emanated linear irradiance at each element, a constant number for uniform illumination. If the total height of the linear light source is H, then H times K should be less than A, i.e. total power emanated should be less than total power going into the light guide. If the complete power going into the light guide is utilized for illumination, then H times K equals A. In an exemplary light source, H times K is kept only slightly less than A, so that only a little power is wasted, as well as volume extinction coefficient is finite.

FIG. 7 illustrates a diagram of an exemplary light source 799 having a varied concentration of diffuser particles, according to one embodiment. The concentration of the diffuser 702 is varied from sparse to dense from the light source end of linear light source column 704 to the opposite end.

FIG. 8 illustrates an exemplary light source 899 having two light sources, according to one embodiment. By using two light sources 808, 809, high variations in concentration of diffuser 802 in the core are not necessary. The differential equation provided is used independently for deriving the emanated linear irradiance due to each of the light sources 808, 809. The addition of these two emanated linear irradiances provides the total emanated linear irradiance at a particular core element.

Uniform illumination for light source 899 is achieved by volume extinction coefficient q=1/sqrt ((h−H/2)̂2+C/K̂2) where sqrt is the square root function, A stands for exponentiation, K is the average emanated linear irradiance per light source (numerically equal to half the total emanated linear irradiance at each element), h is the height of the core element, H is the height of the light source, and C=A (A−HK).

FIG. 9 illustrates a diagram of an exemplary light source 999 having a mirrored core 904, according to one embodiment. By using a mirrored core 904, high variations in the concentration of diffuser 902 in the core 904 is not necessary. Top edge of the core 910 is mirrored, such that it will reflect light back into the core 904. The volume extinction coefficient to achieve uniform illumination in light source 999 is:

q=1/sqrt((h−H)̂2+D/K̂2)
where D=4A (A−HK).

For any system described above (such as the light sources 799, 899 and 999), the same pattern of emanation will be sustained even if the light source power changes. For example, if the primary light source of light source 799 provides half the rated power, each element of the core will emanate half its rated power. Specifically, a light guide core designed to act as a uniform light source as a uniform light source at all power ratings by changing the power of its light source or sources. If there are two light sources, their powers are changed in tandem to achieve this effect.

A polarized light source is disclosed. It is understood that the embodiments described herein are for the purpose of elucidation and should not be considered limiting the subject matter of the present patent. Various modifications, uses, substitutions, recombinations, improvements, methods of productions without departing from the scope or spirit of the present invention would be evident to a person skilled in the art.

We claim:

1. An apparatus, comprising:
a reflector,
a reflecting polarizer,
a transparent light source between the reflector and the reflecting polarizer, and
a wave retarder between the reflector and the reflecting polarizer.

2. The apparatus of claim 1, wherein the reflecting polarizer is a reflecting circular polarizer.

3. The apparatus of claim 1, wherein the reflecting polarizer is a reflecting linear polarizer.

4. The apparatus of claim 1, wherein the wave retarder is a quarter wave retarder.

5. The apparatus of claim 1, wherein the wave retarder is between the transparent light source and reflector.

6. The apparatus of claim 1, wherein the wave retarder is between the transparent light source and reflecting polarizer.

7. The apparatus of claim 1, wherein the transparent light source further comprises a variable concentration of diffuser particles.

8. The apparatus of claim 7, wherein the transparent light source further comprises one or more sections of cladding material.

9. The apparatus of claim 8, wherein the light source provides an emanated linear irradiance according to an equation, the equation is dP/dh=−qP=−K, where h is a distance of a core element to a primary light source, P is a power of light being guided through the core element; q is a volume extinction coefficient of the core element; and K is the emanated linear irradiance.

10. The apparatus of claim 9, wherein the light source provides an uniform illumination having a volume extinction coefficient q equals 1/sqrt ((h−H/2)̂2+C/K̂2) where sqrt is a square root function, A is exponentiation, H is a height of the light source, h is a height of the core element, and C equals A (A−HK)
